(19) United States
(12) Patent Application Publication
(10) Pub. No.: US 2009/0274892 A1
(43) Pub. Date: Nov. 5, 2009

(54) HYDROPHOBIC OPEN CELLED FOAM AND METHOD OF MAKING THE SAME

(76) Inventors: Feng Qin, Charlotte, NC (US); Chad Edward Miller, Marietta, GA (US)

Correspondence Address: HAMMER & ASSOCIATES, P.C., 3125 SPRINGBANK LANE, SUITE G, CHARLOTTE, NC, 28226, US

(21) Appl. No.: 11/761,636

(22) Filed: Jun. 12, 2007

Related U.S. Application Data
(60) Provisional application No. 60/813,517, filed on Jun. 14, 2006.

(51) Int. Cl. B32B 3/26; B05D 5/00

(52) U.S. Cl. 428/318.4; 428/304.4; 427/244

(57) ABSTRACT

A hydrophobic insulating foam for use in, for example, insulating the walls of an aircraft fuselage, includes a base foam and a water repellant coating. The base foam has a plurality of interconnected open cells. The interconnected open cells and the outside of the base foam define a surface area. The water repellant coating is deposited on the surface area. The hydrophobic open celled foam may be made by providing a base foam having a plurality of interconnected open cells, providing a water repellant coating, and depositing the water repellant coating upon the surface area of the provided base foam.

### RELATED APPLICATION

This application claims the benefit of co-pending U.S. Provisional Patent Application Ser. No. 60/813,517 filed Jun. 14, 2006.

### FIELD OF INVENTION

The instant invention relates to a hydrophobic open celled foam and the method of making the same.

### BACKGROUND OF THE INVENTION

Solid foams can be classified into two categories based on their pore structure, open celled foams and closed celled foams. Open celled foams contain pores that are connected to each other and form an interconnected network. Closed celled foams do not have interconnected pores. The closed cell structure foams have higher dimensional stability, a lower moisture absorption coefficient and higher strength compared to open cell structured foams.

Recently, foam has been introduced for insulating the walls of an aircraft fuselage. Insulation for an aircraft fuselage is typically provided between the walls of the fuselage. Aircraft fuselage insulation provides a number of functions including regulation of temperature, reduction of engine noise, reduction of noise from outside air turbulence, flame propagation, burnthrough, smoke and toxicity resistance and water repellency or wicking. Most importantly, because of the constant change in altitude and pressures, insulation for an aircraft fuselage provides protection of mechanical and structural components within the aircraft system from moisture and temperature extremes that might tend to damage or corrode the components. For these reasons, most aircraft manufacturers have very stringent standards regarding all the functions of the aircraft fuselage insulation.

Previously, fiberglass systems were used for insulating the walls of an aircraft fuselage. These systems have been used adequately for many years; however, many problems have been discovered. Fiberglass insulation systems for aircrafts often have problems associated with delamination (splitting apart of layers), respirability, sagging, poor water repellency in bilge water, inability to shed water at seams after entering through penetrations/cutouts, and flammability of films after gathering or accumulating oil/fuel/grime, etc.

Currently, foams have been introduced to solve the problems associated with fiberglass systems. Closed cell foams were originally more desirable than open celled foams when insulating the walls of an aircraft fuselage because they are relatively moisture resistant. However, closed cell foams are un-flexible or brittle (causes cells to break down under compressive loads) this property requires the closed cell foams to be produced in thin layers in order to fit into the spaces between the walls of an aircraft fuselage. Thin closed cell foams do not typically provide adequate noise absorption for use in the aircraft fuselage. As such, a hefty amount of closed cell foam layers must be applied which adds to manufacturing costs in terms of raw material costs, installation costs, weight, and space constraints. Furthermore, because the closed cell structures have a low moisture absorption coefficient, the closed celled foams are difficult, if not impossible, to add a treatment on. Closed celled foams are typically treated with a spray system, curtain coater, etc., however, these systems only treat the outside of the foam and are ineffective in treating the inner cells of the closed cell foam.

It is thus highly desirable to create an open celled foam for insulating the walls of an aircraft fuselage that solves the above mentioned problems and is water repellant or hydrophobic. It is also desirable that the insulation be cost effective in terms of fabrication, installation and life cycle.

### SUMMARY OF THE INVENTION

The instant invention is a hydrophobic open celled foam. The hydrophobic open celled foam includes a base foam and a water repellant coating. The base foam has a plurality of interconnected open cells. The interconnected open cells and the outside of the base foam define a surface area. The water repellant coating is deposited on the surface area. The hydrophobic open celled foam may be made by providing a base foam having a plurality of interconnected open cells, providing a water repellant coating, and depositing the provided water repellant coating upon the surface area of the provided base foam.

### BRIEF DESCRIPTION OF THE DRAWINGS

For the purpose of illustrating the invention, there is shown in the drawings one embodiment of the present invention; it being understood, however, that this invention is not limited to the precise arrangements and instrumentalities shown.

FIG. 1 is a cross-sectional view of a wall of an aircraft fuselage that has been partially insulated with open-celled hydrophobic insulating foam.

### DETAILED DESCRIPTION OF THE INVENTION

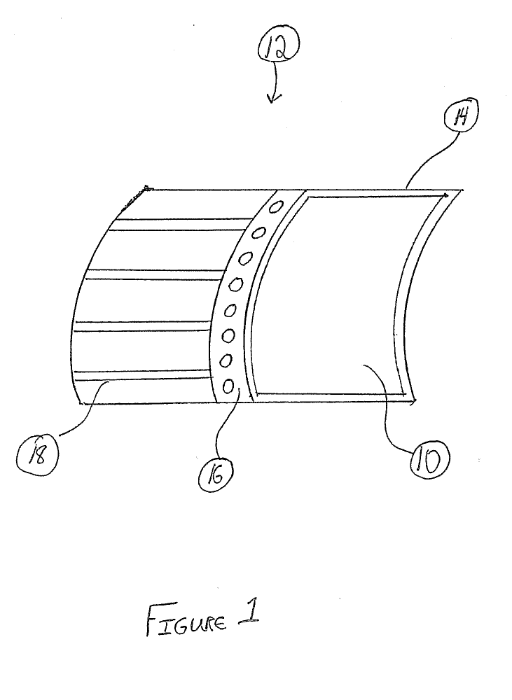

Referring to the drawings, wherein like numerals indicate like elements, there is shown in FIG. 1 a wall of an aircraft fuselage 12 that is partially insulated with a hydrophobic open celled foam 10. Wall 12 may be any wall of an aircraft fuselage. Wall 12 may be constructed by any means, including, but not limited to a box truss structure, a geodesic construction, a monocoque shell or a semi-monocoque. Wall 12 may include an external skin 14. Hydrophobic open celled foam 10 may be juxtaposed to external skin 14. Wall 12 may further include a plurality of trusses 16 and a plurality of stringers 18.

Hydrophobic open celled foam 10 generally may include a base foam and a water repellant coating. Hydrophobic open celled foam 10 may be any hydrophobic open celled foam, or any open celled foam that is water repellant. Hydrophobic open celled foam 10 may be used for many applications, including, but not limited to, insulating the walls of an aircraft fuselage.

The base foam may be included in hydrophobic open celled foam 10. The base foam may be for providing the foundation foam of hydrophobic open celled foam 10. The base foam may be any type of foam, including, but not limited to, a resilient fire resistant foam. A resilient fire resistant foam may be, but is not limited to, a melamine foam. Melamine foam is available from BASF of New Jersey under the trade name BASOTECT®. The base foam may have a number of desired properties, including, but not limited to, low density or low weight, low thermal conductivity, good fire protection, good flexibility, high sound insulation efficiency, etc.

The base foam may be of any structure, including but not limited to, an open celled structure. The open celled structure of the base foam may include a plurality of interconnected open cells. The interconnected open cells in combination with the outside of the base foam may define a surface area. The water repellant coating may be deposited upon the surface area, thus, providing hydrophobic treatment to the base foam. The interconnected open cells, or the open cell structure of the base foam, may provide the access to the entire surface area to apply the hydrophobic treatment to the base foam, or in other words, the water repellant coating.

The water repellant coating may be deposited on or in the surface area of the base foam. The water repellant makes the base foam water repellant. The water repellant coating may be any hydrophobic coating or water repellant substance. In one embodiment, the water repellant substance may be a mixture of water repellant substances, including, but not limited to a mixture of chemicals. For example, the chemical mixture may include, but is not limited to, fluorochemicals, waxes, hydrocarbon emulsions, and mixtures thereof. The fluorochemicals, waxes (or wax emulsions) and hydrocarbon emulsions may be those used to make water repellant textiles. The water repellant coating may range from 1-5% by weight of the base foam (dry add on %).

A method of making hydrophobic open celled foam 10 may be for producing hydrophobic open celled foam 10 and may include any steps for producing the hydrophobic open celled foam. The method may include producing hydrophobic opened celled foam 10 for many uses, including, but not limited to, insulating the walls of an aircraft fuselage. Generally, the method of making hydrophobic open celled foam 10 may include: providing the base foam; providing the water repellant coating; and depositing the water repellant coating on the base foam.

The step of providing the base foam may be included in the method of producing hydrophobic open celled foam 10. This step may be for providing the base foam, or foundation foam for producing the hydrophobic open celled foam. This step may also include providing a base foam having a plurality of interconnected open cells which, in combination with the outside of the base foam, may define the surface area. This step of providing the base foam may include providing a base foam being a resilient flame resistant foam, like a melamine foam. This step of providing the base foam may be providing the base foam in any size, including, but not limited to, 2500×1250×500 mm untreated buns. This step may further include a step of shaping the base foam.

The step of shaping the base foam may be included in the step of providing the base foam. This step may be for shaping the base foam to the desired size for hydrophobic open celled foam 10. This step may include cutting the base foam with any type of cutting machine, including, but not limited to, a machine with dual oscillating blades or a revolving wire. Dual oscillating blades may be one embodiment of the cutting machine because this may reduce dusting and may also enhance cutting surface properties. An example of a machine used for the step of shaping the base foam may be, but is not limited to, a Wintech Contour Cutter equipped with either dual oscillating blades or a revolving wire. This step of shaping the base foam may include cutting the base foam to any thickness, including, but not limited to, a 1 inch thickness or a 3.6 inch thickness.

The step of providing the water repellant coating may be included in the method of producing hydrophobic open celled foam 10. This step may be for providing the water repellant coating, or a hydrophobic treatment for the base foam. This step may include any steps for providing the water repellant coating. This step of providing the water repellant coating may include a step of mixing a solution of the water repellant coating and a liquid in a mix tank, and a step of emulsifying the mixed solution.

The step of mixing a solution of the water repellant coating and a liquid in a mix tank may be included in the step of providing the water repellant coating. This step may be for mixing the water repellant coating with a liquid (e.g. water, alcohol or both). This step may include any steps for mixing the water repellant coating with a liquid. This step may include mixing the water repellant coating with a liquid in a mix tank. The mix tank may be any mix tank for mixing the water repellant coating with a liquid. The mix tank may be a mix tank equipped with agitators to achieve the appropriate concentration of both liquid and solid additives for obtaining a mixed solution. This step of mixing the water repellant coating may include pumping the mixed solution into a blend tank for consolidation.

The step of emulsifying the mixed solution may be included in the step of providing the water repellant coating. This step may be for emulsifying the mixed solution from the previous step of mixing the water repellant coating with a liquid. This step may include any steps for emulsifying the mixed solution. This step may include forcing the mixed solution through an emulsifying device. The emulsifying device may be any device for emulsifying the mixed solution, including, an in-line device that employs pressure and ultrasonic cavitational forces strong enough to emulsify the mixed solution without shearing it. Once the desired level of consistency is achieved in the emulsifying device, an emulsified solution may be formed. The emulsified solution may be piped to a holding tank for application to the base foam.

The step of depositing the water repellant coating on the surface area of the base foam may be included in the method of producing hydrophobic open celled foam 10. This step may be for treating the base foam with the water repellant coating to make the base foam become hydrophobic or repellant to water. This step may include any steps for depositing the water repellant coating on the surface area of the base foam. This step may include, but is not limited to: a step of compressing the base foam; a step of submerging the compressed base foam into the emulsified solution; a step of expanding the submerged base foam thereby absorbing the emulsified solution; a step of allowing the water repellant coating to settle on to the surface area; a step of compressing the base foam to remove the liquid mixed with the water repellant coating; a step of removing the compressed base foam from the emulsified solution; a step of allowing the base foam to expand; a step of drying the treated base foam; and a step of curing the treated base foam.

The step of compressing the base foam may be included in the step of depositing the water repellant coating on the surface area of the base foam. This step may be for compressing the base foam to allow for the base foam to expand when submerged in the emulsified solution. This step may include any step for compressing the base foam. This step may include moving the base foam through a first pair of nip rollers for completely compressing the base foam.

The step of submerging the compressed base foam into the emulsified solution may be included in the step of depositing the water repellant coating on the surface area of the base foam. This step may be for submerging the compressed base foam into the emulsified solution to allow for the introduction of the emulsified solution into the base foam. This step may include any steps for submerging the compressed base foam into the emulsified solution, including but not limited to, manual or by an automated process.

The step of expanding the submerged base foam may be included in the step of depositing the water repellant coating on the surface area of the base foam. This step may be for absorbing the emulsified solution through the walls of the surface area. This step may include any steps for expanding the submerged base foam. This step may include, but is not limited to, compression by a perforated roll with a pneumatic height adjustment to keep the base foam submerged. The perforated roll may be set up to react automatically to a signal generated by a depth gauge mounted in the tank.

The step of allowing the water repellant coating to settle on to the surface area may be included in the step of depositing the water repellant coating on the surface area of the base foam. This step may be for allowing the water repellant coating to settle on to the surface area. This step may include any steps for allowing the water repellant coating to settle on to the surface area. This step may include allowing the base foam to stay submerged for any period of time, for example, until the base foam becomes fully saturated with the emulsified solution of the water repellant coating.

The step of compressing the base foam to remove the liquid mixed with the water repellant coating may be included in the step of depositing the water repellant coating on the surface area of the base foam. This step may be for compressing the base foam to remove the liquid mixed with the water repellant coating from the base foam, thus treating the base foam with the water repellant coating. This step may include any steps for removing the liquid mixed with the water repellant coating. In this step of compressing the base foam, the plurality of interconnected cell walls may filter, or maintain, the water repellant coating which will ultimately make the base foam hydrophobic. This step may include moving the base foam through a second pair of nip rollers for completely compressing the treated base foam.

The step of removing the compressed treated base foam from the emulsified solution may be included in the step of depositing the water repellant coating on the surface area of the base foam. This step may be for removing the compressed treated base foam from the emulsified solution to allow for drying and curing. This step may include any steps for removing the treated base foam from the emulsified solution, including, but not limited to, manually or by an automated process.

The step of expanding the treated base foam may be included in the step of depositing the water repellant coating on the surface area of the base foam. This step may be for expanding the treated base foam to allow for drying and curing of the treated base foam. This step may include any steps for allowing the treated base foam to expand. This step may include removing the treated base foam from the second pair of nip rollers.

The step of drying the treated base foam may be included in the step of depositing the water repellant coating on the surface area of the base foam. This step may be for drying or removing the excess liquid not removed by compression in the previous step from the treated base foam. This step may include any steps for drying the treated base foam. This step may include applying a vacuum to the treated base foam, for example, moving the treated base foam through a vacuum table.

The step of curing the treated base foam may be included in the step of depositing the water repellant coating on the surface area of the base foam. This step may be for curing the water repellant coating onto the surface area of the base foam. This step may include any steps for curing the treated base foam. This step may include inserting the treated base foam into an oven. The oven may be any oven, including, but not limited to an oven with vents and baffles adapted for even distribution of air flow across and through the treated base foam. Curing time may be any time necessary, including, but not limited to 5 to 35 minutes. For example, the curing time for 1 inch thick treated base foam may be 5-11 minutes and the curing time for 3.6 inch thick treated base foam may be 25-35 minutes.

### Water Repellency Tests:

Submerging Test: Each 1″ thick foam sample is cut to 10″×10″ and is submerged in water (5″ below surface) for 15 minutes. The weight gain is measured after dripping for 1 minute. 72 Hour Float Test: Each 0.5″ thick foam is cut to 7″7″ and is floated at room temperature on water for 72 hours. The weight gain is measured as a percentage of the original foam weight.

### Experiment 1

In the initial lab trials, 1″ thick foam samples at about 12″×12″ size were treated with the water repellant coating 14 and cured in convection lab ovens.

Table 1 shows the results of the Submerging Test of 17 samples (1″ thickness). Eight of the samples were treated using Group 1 (labeled in table 1 as N), mixtures of fluorochemicals only, and nine using Group 2 (labeled in table 1 as F), mixtures of fluorochemicals, waxes and flourocarbons. More specifically, Group 2 consisted of four fluorochemicals, a paraffin wax emulsion and a hydrocarbon emulsion. The samples in Table 1 varied with formulas and nip pass/pressures from 100% to 250%. The oven temperature was 180 C and curing time varies from 6 minutes to 20 minutes:

TABLE 1
Test results for water absorption during the Submerging Test.

| | Water repellant coating Dry Add-on | | | | | | | Treated Foam Weight | | |
|---|---|---|---|---|---|---|---|---|---|---|
| | (As percentage of the untreated foam weight) | | | | | | | Gain in Submerging Test | | |
| | FC | FC | FC | FC | HC | HC | | Dry | Wet | Weight |
| Sample | 400 | 300 | 200 | 100 | 1 | 120 | Total | (g) | (g) | Gain (g) |

Group 1

| | | | | | | | | | |
|---|---|---|---|---|---|---|---|---|---|
| 1-1 | | 1.63% | | | | 1.63% | 12.9 | 36.2 | 23.3 |
| 1-2 | | 1.25% | | | 1.45% | 2.71% | 15.0 | 56.5 | 41.6 |
| 1-3 | | | 2.35% | 0.39% | 1.31% | 4.05% | 14.5 | 19.8 | 5.3 |
| 1-3B | | | 1.47% | 0.24% | 0.82% | 2.53% | 14.8 | 21.5 | 6.8 |
| 1-4 | | 1.27% | | 0.35% | 1.18% | 2.80% | 14.6 | 33.4 | 18.7 |
| 1-5 | | | 1.20% | 0.20% | 0.50% | 1.90% | 15.4 | 31.7 | 16.3 |
| 1-6 | | 0.40% | | 0.30% | 0.93% | 1.63% | 15.2 | 54.9 | 39.7 |
| 1-7 | 2.16% | | | | | 2.16% | 15.5 | 24.5 | 9.0 |

Group 2

| | | | | | | | |
|---|---|---|---|---|---|---|---|
| 2-1 | | 0.35% | | 0.35% | 14.5 | 53.3 | 38.8 |
| 2-2 | | 0.32% | 0.32% | 0.63% | 14.5 | 49.5 | 35.1 |
| 2-3 | 0.58% | | 0.58% | 1.16% | 15.3 | 45.0 | 29.8 |
| 2-4 | | 0.95% | | 0.95% | 14.8 | 31.2 | 16.4 |
| 2-5 | 2.30% | | | 2.30% | 15.3 | 103.9 | 88.6 |
| 2-6 | | 1.54% | | 1.54% | 14.8 | 31.6 | 16.8 |
| 2-7 | 4.37% | | | 4.37% | 15.0 | 76.5 | 61.6 |
| 2-8 | | 1.85% | 1.23% | 3.08% | 15.8 | 29.4 | 13.6 |
| 2-9 | | 2.56% | | 2.56% | 15.0 | 29.8 | 14.8 |

FC 100 = A Fluorocarbon Solution
FC 200 = A Fluorocarbon Solution
FC 300 = A Fluorocarbon Solution
FC 400 = A Fluorocarbon Solution
HC 1 = A hydrocarbon emulsion
HC 120 = A paraffin wax emulsion

The results for experiment 1 showed that we have multiple formulas in both Group One and Group Two that can treat the melamine foam to make the foam hydrophobic according to the Water Repellency tests. The results also showed that some fluorochemicals were more efficient on melamine foam than the others in the wet process.

### Experiment 2

Foam size was about 12″×12″. Curing time was 5-11 min for 1″ foam, and 25-35 min to 3.6″ foam. The temperature of the through-air drying/curing oven was about 190 C. Treated foam samples are cut to 7″×7″ (˜0.5″ thick) and are floated on water for 72 hours in room temperature.

TABLE 2
Results of 72 Hour Float Test for Lab Trials Treating 1″
Foam and 3.625″ Foam in an Air-Through Oven.

| | | | | | |
|---|---|---|---|---|---|
| | FC 100 | | | | Average |
| | Chemical | Dry | Weight | Weight | weight |
| Foam | Dry Add | Weight | after | gain % after | gain % after |
| Samples | on (%) | (g) | 72 h (g) | 72 h (%) | 72 h (%) |

1″ Thick Samples

| | | | | | |
|---|---|---|---|---|---|
| G2 | 1.92% | 2.95 | 3.25 | 10.17% | 10.40% |
| | | 4.89 | 5.41 | 10.63% | |
| G4 | 1.85% | 3.7 | 4.06 | 9.73% | 8.35% |
| | | 4.3 | 4.6 | 6.98% | |
| G5 | 2.37% | 3.5 | 3.84 | 9.71% | 8.59% |
| | | 4.56 | 4.9 | 7.46% | |
| G6 | 3.16% | 3.31 | 3.86 | 16.62% | 11.67% |
| | | 4.46 | 4.76 | 6.73% | |

3.6″ Thick Samples

| | | | | | |
|---|---|---|---|---|---|
| G1 | 2.64% | 4.05 | 4.45 | 9.88% | 11.71% |
| | | 3.65 | 3.97 | 8.77% | |
| | | 3.81 | 4.13 | 8.40% | |
| | | 4.39 | 4.79 | 9.11% | |
| | | 4.13 | 4.42 | 7.02% | |
| | | 6.65 | 8.45 | 27.07% | |
| G3 | 2.43% | 3.86 | 4.69 | 21.50% | 11.36% |
| | | 4.22 | 4.59 | 8.77% | |
| | | 4.2 | 4.53 | 7.86% | |
| | | 4.19 | 4.51 | 7.64% | |
| | | 4.5 | 4.84 | 7.56% | |
| | | 5.26 | 6.04 | 14.83% | |

The present invention may be embodied in other forms without departing from the spirit and the essential attributes thereof, and, accordingly, reference should be made to the appended claims, rather than to the foregoing specification, as indicated in the scope of the invention.

We claim:

1. A wall of an aircraft fuselage comprising:
an external skin with a hydrophobic open celled foam insulation juxtaposed thereto, said hydrophobic insulating foam comprising:
a base foam having a plurality of interconnected open cells;
said interconnected open cells and the outside of said base foam defining a surface area; and
a water repellant coating being deposited upon said surface area.

2. The wall of an aircraft fuselage of claim 1 where said base foam being a resilient flame resistant foam.

3. The wall of an aircraft fuselage of claim 2 where said resilient flame resistant foam being a melamine foam.

4. The wall of an aircraft fuselage of claim 1 where said water repellant coating being a mixture of water repellant chemicals selected from the group consisting of fluorochemicals, waxes, and liquid hydrocarbons.

5. A method of making a hydrophobic open celled foam comprising the steps of:
providing a base foam having a plurality of interconnected open cells;
said interconnected open cells and the outside walls of said base foam defining a surface area;
providing a water repellant coating; and
depositing said water repellant coating upon said surface area.

6. The method of claim 5 where said base foam being a resilient flame resistant foam.

7. The method of claim 6 where said resilient flame resistant foam being a melamine foam.

8. The method of claim 5 where said water repellant coating being a mixture of water repellant chemicals selected from the group consisting of fluorochemicals, waxes, and liquid hydrocarbons.

9. The method of claim 5 where said hydrophobic open celled foam being used in insulating the walls of an aircraft fuselage.

10. The method of claim 5 where said step of providing said base foam includes the step of shaping said base foam.

11. The method of claim 10 where said step of shaping said base foam comprising the step of cutting said base foam.

12. The method of claim 5 where said step of providing a water repellant coating comprising the steps of:
mixing a solution of said coating and a liquid in a mix tank; and
emulsifying said mixed solution.

13. The method of claim 5 where said step of depositing a water repellant coating upon said surface area comprising the steps of:
compressing said foam;
submerging said compressed foam into said emulsified solution;
expanding said submerged foam, thereby absorbing said emulsified solution;
allowing said coating to settle on to said surface area, thereby treating said foam;
compressing said foam to remove the liquid mixed with said water repellant coating;
removing said compressed treated foam from said solution;
allowing said treated foam to expand;
drying said treated foam; and
curing said treated foam.

14. The method of claim 13 where said compressing steps including moving said foam through a pair of nip rollers.

15. The method of claim 13 where said curing step including inserting said foam into an oven being adapted for even distribution of air flow across and through said foam.

16. A hydrophobic open celled foam comprising:
a base foam having a plurality of interconnected open cells;
said interconnected open cells and the outside of said base foam defining a surface area; and
a water repellant coating being deposited upon said surface area.

17. The hydrophobic open celled foam of claim 16 where said base foam being a resilient flame resistant foam.

18. The hydrophobic open celled foam of claim 17 where said resilient flame resistant foam being a melamine foam.

19. The hydrophobic open celled foam of claim 16 where said water repellant coating being a mixture of water repellant chemicals selected from the group consisting of fluorochemicals, waxes, and liquid hydrocarbons.

20. The hydrophobic open celled foam of claim 16 being used in insulating the walls of an aircraft fuselage.
